(19) United States
(12) Patent Application Publication
(10) Pub. No.: US 2009/0154834 A1
(43) Pub. Date: Jun. 18, 2009

(54) RENDERING SYSTEM AND DATA PROCESSING METHOD FOR THE SAME

(75) Inventors: Yun Ji Ban, Daejeon (KR); Hye-Sun Kim, Daejeon (KR); Chung Hwan Lee, Daejeon (KR); Jin Sung Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/333,902

(22) Filed: Dec. 12, 2008

(30) Foreign Application Priority Data
Dec. 15, 2007 (KR) 10-2007-0131822

(51) Int. Cl. G06K 9/36

(52) U.S. Cl. 382/284

(57) ABSTRACT

The rendering system for rendering input image data to composite an image includes an image input unit, an image rendering unit, an image compositing unit. The image input unit subdivides input image data into data segments of a size corresponding to the memory capacity of the rendering system to load the data segments one at a time. The image rendering unit renders the data segments in sequence, and sequentially stores rendering pixel information associated with the rendered results in a buffer. The image compositing unit compares two pieces of stored rendering pixel information to each other as previous rendering pixel information and current rendering pixel information, updates rendering pixel information according to the comparison result, and composites a final image according to the updated rendering pixel information.

### CROSS-REFERENCE(S) TO RELATED APPLICATIONS

The present invention claims priority of Korean Patent Application No. 10-2007-0131822, filed on Dec. 15, 2007, which is incorporated herein by reference.

### FIELD OF THE INVENTION

The present invention relates to a rendering system; and, more particularly, to a rendering system and data processing method for the same that are suitable to divide scene data into data segments, separately render the data segments, and combine rendered results together.

This work was supported by the IT R&D program of MIC/IITA. [2006-S-045-02, Development of Function Extensible Real-Time Renderer]

### BACKGROUND OF THE INVENTION

With recent enhancements in performance of computers, three-dimensional computer graphics has been applied to various fields including filmmaking, advertisement, gaming and animation. In particular, advances in graphics technologies have enabled creation of images comparable to actually photographed images, and generated a need for a technique representing more realistic images.

Representation of photorealistic images requires a large amount of data, and rendering thereof requires high-end computer systems. Creation of such images requires both long computation times of computers and many work hours of designers. Accordingly, much effort has been made to research and develop techniques to solve these problems.

For example, in existing rendering method, input scene data is manually divided by a graphic designer into data segments, the data segments are separately rendered, and rendered results are combined together. Input scene data is divided by objects into data segments in area subdivision scheme, and then the data segments are separately rendered through simulation based on subdivision.

There is a simulation procedure including the following steps: repeatedly subdividing the whole simulation area into area segments until the number of objects in each area segment is not greater than a predetermined number; and performing simulation on objects in each area segment and storing simulation results until a termination condition is satisfied, and There is a rendering procedure including the following steps: repeatedly subdividing the whole rendering area into area segments until the number of objects in each area segment is not greater than a predetermined number; performing rendering on each area segment; and combining rendered results together to provide the same into a whole screen for final rendering output.

However, in existing rendering schemes, manual area subdivision and rendering requires a very sophisticated compositing technique and may cause a severe problem at a composited portion of the scene due to depth errors. Rendering based on area subdivision requires a special image subdividing technique and may cause a mismatch between subdivisions during composition.

### SUMMARY OF THE INVENTION

It is, therefore, an object of the present invention to provide a rendering system and data processing method using the same wherein scene data is subdivided into data segments according to the system memory capacity, the data segments are separately rendered, and the rendered results are combined together.

In accordance with one aspect of the present invention, there is provided a rendering system for rendering input image data to composite an image, including an image input unit subdividing the input image data into data segments of a size corresponding to the memory capacity of the rendering system, and loading the data segments one at a time; an image rendering unit rendering the data segments in sequence, and sequentially storing rendering pixel information associated with the rendered results in a buffer; and an image compositing unit comparing two pieces of stored rendering pixel information to each other as previous rendering pixel information and current rendering pixel information, updating rendering pixel information according to the comparison result, and compositing a final image according to the updated rendering pixel information.

It is preferred that the rendering system further includes a rendering buffer unit temporarily storing rendering pixel information in sequence, sending the rendering pixel information to the image compositing unit, and temporarily storing the undated rendering pixel information from the image compositing unit.

It is also preferred that the image compositing unit compares depth values of a previous pixel candidate and current pixel candidate to each other, and compares alpha values thereof to each other, using the previous and current rendering pixel information.

It is desirable that the image compositing unit checks, when the depth value of the current pixel candidate is less than that of the previous pixel candidate, the alpha value of the current pixel candidate, and further updates, when the alpha value of the current pixel candidate is present, rendering pixel information associated with the current pixel candidate.

It is also desirable that the image compositing unit replaces, when the alpha value of the current pixel candidate is not present, the previous rendering pixel information with the rendering pixel information associated with the current pixel candidate.

It is preferable that the image compositing unit determines, when the depth value of the current pixel candidate is greater than that of the previous pixel candidate, whether to output rendering pixel information of the current pixel candidate to the screen by checking the alpha value of the previous pixel candidate.

It is also preferable that the image compositing unit further updates rendering pixel information of the previous pixel candidate when the alpha value of the previous pixel candidate is present, and keeps the previous rendering pixel information when the alpha value of the previous pixel candidate is not present.

It is preferred that the rendering pixel information includes color values (RGB), the alpha value, and the depth value.

In accordance with another aspect of the present invention, there is provided a data processing method for a rendering system rendering input image data to composite an image, including subdividing the input image data into data segments of a size corresponding to the memory capacity of the rendering system, and loading the data segments one at a time; rendering the data segments in sequence, and sequentially storing rendering pixel information associated with the rendered results; comparing two pieces of stored rendering pixel information to each other as previous rendering pixel information and current rendering pixel information, and updating rendering pixel information according to the comparison result; compositing an image using the updated rendering pixel information; and repeating rendering, comparing, and compositing until the image is completed.

It is desirable that the comparing two pieces of stored rendering pixel information includes comparing depth values of a previous pixel candidate and current pixel candidate to each other, and checking alpha values thereof to each other, using the previous and current rendering pixel information.

It is also desirable that the comparing two pieces of stored rendering pixel information includes checking, when the depth value of the current pixel candidate is less than that of the previous pixel candidate, the alpha value of the current pixel candidate, and further updating, when the alpha value of the current pixel candidate is present, rendering pixel information associated with the current pixel candidate.

It is preferred that the comparing two pieces of stored rendering pixel information includes replacing, when the alpha value of the current pixel candidate is not present, the previous rendering pixel information with the rendering pixel information associated with the current pixel candidate.

It is also preferred that the comparing two pieces of stored rendering pixel information includes determining, when the depth value of the current pixel candidate is greater than that of the previous pixel candidate, whether to output the rendering pixel information of the current pixel candidate to the screen by checking the alpha value of the previous pixel candidate.

It is desirable that the comparing two pieces of stored rendering pixel information includes further updating rendering pixel information of the previous pixel candidate when the alpha value of the previous pixel candidate is present, and keeping the previous rendering pixel information when the alpha value of the previous pixel candidate is not present.

It is also desirable that the rendering pixel information includes color values (RGB), the alpha value, and the depth value.

In existing subdivision approaches, scene data is subdivided into data segments through a manual process by a designer or in a preset manner, the data segments are separately rendered, and rendered results are combined together. Unlike these, in the approach of the present invention, a large amount of input image data is subdivided into data segments according to the system memory capacity, the data segments are loaded in sequence and rendered, the rendering pixel information is stored in sequence and updated gradually, and a final image is composited using the stored and updated rendering pixel information. Hence, the approach of the present invention enables effective performance of large-scale rendering and image composition for a three-dimensional photo-realistic film and advertisement regardless of the rendering system capacity.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a rendering system suitable for image rendering and compositing through subdivision according to an embodiment of the present invention;

FIG. 2 illustrates a rendering buffer in the rendering system of FIG. 1 to temporarily store rendering pixel information; and

FIG. 3 is a flowchart illustrating a data processing method for the rendering system of FIG. 1 according to another embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

The present invention relates to a rendering technique including the following steps: automatically subdividing input image data into data segments according to the system memory capacity; rendering a first data segment, storing rendering pixel information associated with the rendered results, and creating a corresponding image; and repeating rendering a next data segment, updating the previous rendering pixel information with the current rendering pixel information, and compositing the current image and previous image together according to the updated rendering pixel information until a whole image corresponding to all the data segments is completed. Thereby, the rendering technique of the present invention can overcome shortcomings of existing techniques.

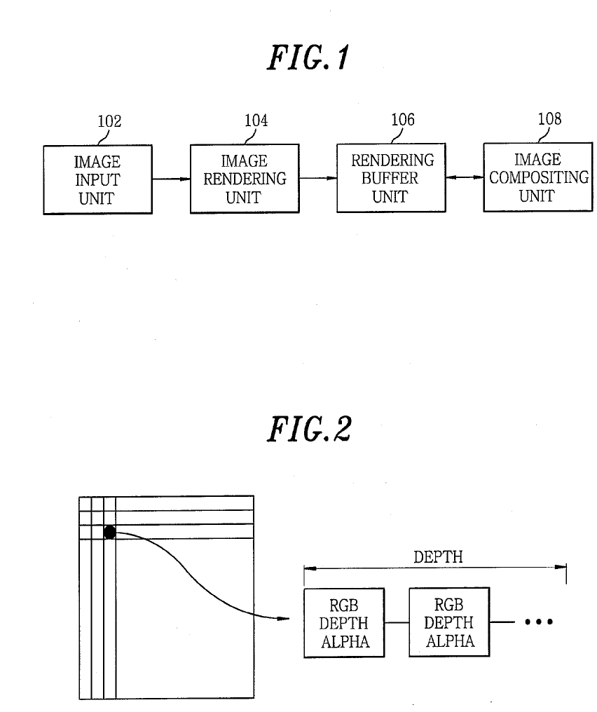

FIG. 1 is a block diagram illustrating a rendering system suitable for image rendering and compositing through subdivision according to an embodiment of the present invention. Referring to FIG. 1, the rendering system includes an image input unit 102, image rendering unit 104, rendering buffer unit 106, and image compositing unit 108.

The image input unit 102 subdivides input image data (scene data) into data segments and loads the data segments. That is, for a large amount of input image data, the image input unit 102 checks the available memory capacity of the rendering system, subdivides the input image data into data segments of a size corresponding to the memory capacity, and sends the data segments one at a time to the image rendering unit 104.

The image rendering unit 104 renders input image data through scanline rendering and the like. That is, when a data segment of a size corresponding to the memory capacity is received from the image input unit 102, the image rendering unit 104 renders the received data segment through scanline rendering, and sends rendering pixel information associated with the rendered result to the rendering buffer unit 106 for temporary storage. This process is repeated for all the data segments. The rendering pixel information associated with the rendered result may include color values (RGB: red, green, and blue), a depth value (Z-value), and an alpha value (A-value, pixel transparency).

When a first data segment arrives, the image rendering unit 104 renders the first data segment and temporarily stores rendering pixel information associated with the rendered result in the rendering buffer unit 106 as previous rendering pixel information. When a next data segment arrives, the image rendering unit 104 renders the next data segment and temporarily stores rendering pixel information associated with the rendered result in the rendering buffer unit 106 as current rendering pixel information. These operations are repeatedly performed in sequence.

The rendering buffer unit 106 temporarily stores rendering pixel information. The rendering buffer unit 106 temporarily stores rendering pixel information associated with rendered results from the image rendering unit 104, forwards the rendering pixel information to the image compositing unit 108, and temporarily stores updated rendering pixel information from the image compositing unit 108. That is, the rendering buffer unit 106 temporarily stores current rendering pixel information, forwards the current rendering pixel information and pre-stored previous rendering pixel information to the image compositing unit 108, and temporarily stores updated rendering pixel information from the image compositing unit 108 as previous rendering pixel information.

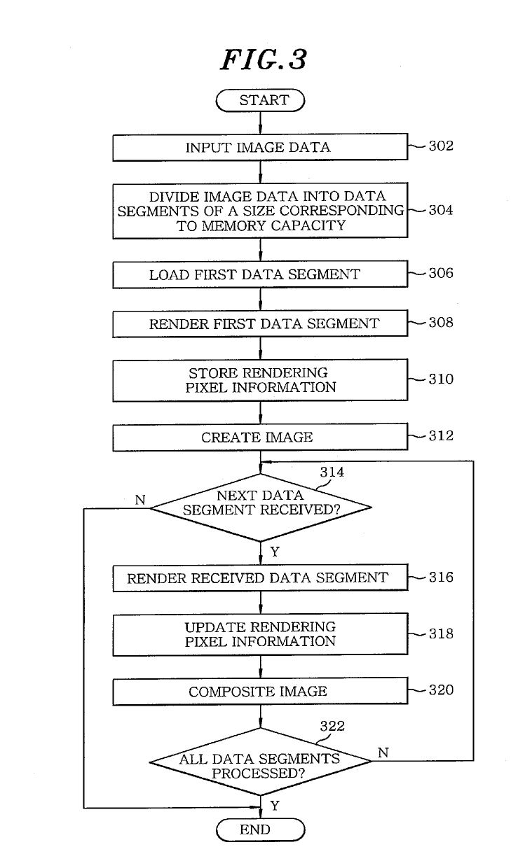

FIG. 2 illustrates a rendering buffer in the rendering system of FIG. 1 to temporarily store rendering pixel information. Referring to FIG. 2, a buffer associated with a pixel in a rendered scene is managed as a linked list, and elements of the buffer can be generated, added and deleted according to their depth values. In the screen, an element with a large depth value appears after another element with a small depth value (in FIG. 2, the depth increases from left to right). When a pixel is rendered multiple times, pixel information is automatically accumulated and stored through buffer update. Hence, when the contents of the buffer are displayed as images on the screen, it is sufficient to output previously stored rendering pixel information.

The image compositing unit 108 composites an image according to rendering pixel information. That is, the image compositing unit 108 creates an image according to rendering pixel information of the first data segment. When rendering pixel information of the next data segment arrives, the image compositing unit 108 extracts the previous rendering pixel information from the rendering buffer unit 106, compares the previous rendering pixel information with the current rendering pixel information, updates rendering pixel information according to the comparison result and sends the updated rendering pixel information to the rendering buffer unit 106, and composites the image according to the updated rendering pixel information. These operations are repeated in sequence until all the data segments are processed.

To be more specific for comparison of rendering pixel information, it is assumed that a pixel candidate A is created according to current rendering pixel information and a pixel candidate B is created according to previous accumulated rendering pixel information. The image compositing unit 108 compares rendering pixel information of A, associated with the rendered result of the current data segment, to rendering pixel information of B (previous rendering pixel information). First, the depth value of A is compared to that of B to identify which one is closer to the viewer.

If the depth value of A is less than that of B (i.e., A is closer to the viewer than B), the image compositing unit 108 checks the alpha value (transparency) of A. If the alpha value of A is present (transparent), the image compositing unit 108 further updates the rendering pixel information of A. Rendering pixel information of A and B is stored in sequence in order of depth in the rendering buffer unit 106, and a buffer is managed using a linked list.

If the alpha value of A is not present (opaque), the image compositing unit 108 replaces the previous rendering pixel information in the rendering buffer unit 106 with the rendering pixel information of A. That is, the corresponding pixel has only the rendering pixel information of A, only the rendering pixel information of A is outputted to the screen, and the rendering pixel information of B is removed.

On the other hand, if the depth value of A is greater than that of B (i.e., B is closer to the viewer than A), the image compositing unit 108 checks the alpha value (transparency) of B to determine whether to output the rendering pixel information of A to the screen. If the alpha value of B is present (transparent), information of A is viewed behind that of B in the screen. Hence, the image compositing unit 108 further updates the rendering pixel information of B. If the alpha value of B is not present (opaque), information of A is completely covered by that of B in the screen and it is sufficient to store only the rendering pixel information of B. Hence, the image compositing unit 108 keeps the previous rendering pixel information without performing a rendering pixel information update.

Accordingly, the rendering system can subdivide large input image data into data segments according to the system memory capacity, load the data segments one at a time, and render the data segments in sequence while storing and updating rendering pixel information to composite a final image.

Next, a data processing method for the rendering system is described. To composite a final image, the data processing method includes the following steps: subdividing input image data into data segments according to the system memory capacity; rendering a first data segment, temporarily storing rendering pixel information associated with the rendered result, and creating a corresponding image; and repeating rendering a next data segment, temporarily storing current rendering pixel information associated with the rendered result, comparing the previous rendering pixel information to the current rendering pixel information, and updating rendering pixel information according to the comparison result until all the data segments are rendered.

FIG. 3 is a flowchart illustrating a data processing method using image subdivision according to another embodiment of the present invention.

Referring to FIG. 3, when a large amount of input image data (scene data) is input to the rendering system (step 302), the image input unit 102 checks the available memory capacity of the rendering system, subdivides the input image data into data segments of a size corresponding to the memory capacity (step 304), and sends the data segments one at a time to the image rendering unit 104 (step 306).

Upon reception of a data segment, the image rendering unit 104 renders the input data segment through scanline rendering (step 308), and sends rendering pixel information associated with the rendered result to the rendering buffer unit 106 for temporary storage (step 310). The rendering pixel information may include color values (RGB), a depth value (Z-value), and an alpha value (A-value, pixel transparency).

The image compositing unit 108 extracts the rendering pixel information (color, depth, and alpha values) from the rendering buffer unit 106 and creates an image corresponding to the rendering pixel information (step 312). Thereafter, this rendering pixel information is stored as the previous rendering pixel information.

The image rendering unit 104 checks whether a next data segment is received (step 314).

If a next data segment is received, the image rendering unit 104 renders the received data segment through scanline rendering and sends rendering pixel information associated with the rendered result to the rendering buffer unit 106 for temporary storage as current rendering pixel information (step 316).

The image compositing unit 108 extracts the previous and current rendering pixel information from the rendering buffer unit 106, compares the previous rendering pixel information with the current rendering pixel information, and updates rendering pixel information according to the comparison result (step 318). The updated rendering pixel information is treated later as previous rendering pixel information.

To be more specific for pixel information comparison, it is assumed that a pixel candidate A is created according to current rendering pixel information and a pixel candidate B is created according to previous accumulated rendering pixel information. The image compositing unit 108 compares the depth value of A to that of B to identify which one is closer to the viewer in the screen, checks the alpha value (transparency) of A if the depth value of A is less than that of B, and further updates the rendering pixel information of A if the alpha value is present. Rendering pixel information of A and B is stored in sequence in order of depth in the rendering buffer unit 106, and a buffer is managed using a linked list.

If the alpha value of A is not present, the image compositing unit 108 replaces the previous rendering pixel information in the rendering buffer unit 106 with the rendering pixel information of A. That is, the corresponding pixel has only the rendering pixel information of A, only the rendering pixel information of A is output to the screen, and the rendering pixel information of B is removed.

On the other hand, if the depth value of A is greater than that of B, the image compositing unit 108 checks the alpha value (transparency) of B to determine whether to output the rendering pixel information of A to the screen. If the alpha value of B is present (transparent), information of A is viewed behind that of B in the screen. Hence, the image compositing unit 108 further updates the rendering pixel information of B. If the alpha value of B is not present, information of A is completely covered by that of B in the screen and it is sufficient to store only the rendering pixel information of B. Hence, the image compositing unit 108 keeps the previous rendering pixel information without performing a rendering pixel information update.

Thereafter, the image compositing unit 108 composites an image according to the updated rendering pixel information (step 320).

The image compositing unit 108 checks whether all the data segments are processed for compositing the final image (step 322).

If all the data segments are not processed, steps 314 to 320 are repeated in sequence until all the data segments are processed.

Accordingly, the data processing method can subdivide large input image data into data segments according to the system memory capacity, load the data segments one at a time, render the data segments in sequence while storing and updating rendering pixel information, and composite a final image using the updated rendering pixel information.

While the invention has been shown and described with respect to the embodiments, it will be understood by those skilled in the art that various changes and modifications may be made without departing from the scope of the invention as defined in the following claims.

What is claimed is:

1. A rendering system for rendering input image data to composite an image, comprising:
an image input unit subdividing the input image data into data segments of a size corresponding to a memory capacity of the rendering system, and loading the data segments one at a time;
an image rendering unit rendering the data segments in sequence, and sequentially storing rendering pixel information associated with the rendered results in a buffer; and
an image compositing unit comparing two pieces of stored rendering pixel information to each other as previous rendering pixel information and current rendering pixel information, updating the rendering pixel information according to the comparison result, and compositing a final image according to the updated rendering pixel information.

2. The rendering system of claim 1, further comprising a rendering buffer unit temporarily storing rendering pixel information in sequence, sending the rendering pixel information to the image compositing unit, and temporarily storing the undated rendering pixel information from the image compositing unit.

3. The rendering system of claim 1, wherein the image compositing unit compares depth values of a previous pixel candidate and current pixel candidate to each other, and compares alpha values thereof to each other, using the previous and the current rendering pixel information, and
wherein the previous and the current pixel candidate are produced from the previous and the current rendering pixel information, respectively.

4. The rendering system of claim 3, wherein the image compositing unit checks, when the depth value of the current pixel candidate is less than that of the previous pixel candidate, the alpha value of the current pixel candidate, and further updates, when the alpha value of the current pixel candidate is present, the previous rendering pixel information associated with the current pixel candidate.

5. The rendering system of claim 4, wherein the image compositing unit replaces, when the alpha value of the current pixel candidate is not present, the previous rendering pixel information with the current rendering pixel information associated with the current pixel candidate.

6. The rendering system of claim 3, wherein the image compositing unit determines, when the depth value of the current pixel candidate is greater than that of the previous pixel candidate, whether to output the rendering pixel information of the current pixel candidate to a screen by checking the alpha value of the previous pixel candidate.

7. The rendering system of claim 6, wherein the image compositing unit further updates the previous rendering pixel information of the previous pixel candidate when the alpha value of the previous pixel candidate is present, and keeps the previous rendering pixel information when the alpha value of the previous pixel candidate is not present.

8. The rendering system of claim 7, wherein the rendering pixel information comprises color values (RGB), the alpha value, and the depth value.

9. A data processing method using a rendering system rendering input image data to composite an image, comprising:
subdividing the input image data into data segments of a size corresponding to a memory capacity of the rendering system, and loading the data segments one at a time;
rendering the data segments in sequence, and sequentially storing rendering pixel information associated with the rendered results;
comparing two pieces of stored rendering pixel information to each other as previous rendering pixel information and current rendering pixel information, and updating the rendering pixel information according to the comparison result;
compositing an image using the updated rendering pixel information; and
repeating the rendering, the comparing, the updating and the compositing until the image is completed.

10. The data processing method of claim 9, wherein the comparing two pieces of stored rendering pixel information comprises comparing depth values of a previous pixel candidate and a current pixel candidate to each other, and checking alpha values thereof to each other, using the previous and the current rendering pixel information, and
wherein the previous and the current pixel candidate are produced from the previous and the current rendering pixel information, respectively.

11. The data processing method of claim 10, wherein the comparing two pieces of stored rendering pixel information comprises checking, when the depth value of the current pixel candidate is less than that of the previous pixel candidate, the alpha value of the current pixel candidate, and further updating, when the alpha value of the current pixel candidate is present, the current rendering pixel information associated with the current pixel candidate.

12. The data processing method of claim 11, wherein the comparing two pieces of stored rendering pixel information comprises replacing, when the alpha value of the current pixel candidate is not present, the previous rendering pixel information with the current rendering pixel information associated with the current pixel candidate.

13. The data processing method of claim 12, wherein the comparing two pieces of stored rendering pixel information comprises determining, when the depth value of the current pixel candidate is greater than that of the previous pixel candidate, whether to output the current rendering pixel information of the current pixel candidate to a screen by checking the alpha value of the previous pixel candidate.

14. The data processing method of claim 13, wherein the comparing two pieces of stored rendering pixel information comprises further updating the previous rendering pixel information of the previous pixel candidate when the alpha value of the previous pixel candidate is present, and keeping the previous rendering pixel information when the alpha value of the previous pixel candidate is not present.

15. The data processing method of claim 10, wherein the rendering pixel information comprises color values (RGB), the alpha value, and the depth value.

16. The data processing method of claim 11, wherein the rendering pixel information comprises color values (RGB), the alpha value, and the depth value.

17. The data processing method of claim 12, wherein the rendering pixel information comprises color values (RGB), the alpha value, and the depth value.

18. The data processing method of claim 13, wherein the rendering pixel information comprises color values (RGB), the alpha value, and the depth value.

19. The data processing method of claim 14, wherein the rendering pixel information comprises color values (RGB), the alpha value, and the depth value.
